(19) United States
(12) Patent Application Publication
(10) Pub. No.: US 2006/0152711 A1
(43) Pub. Date: Jul. 13, 2006

(54) Non-contact vehicle measurement method and system

(76) Inventors: James L. Dale JR., Conway, AR (US); Stephen L. Glickman, Los Gatos, CA (US)

Correspondence Address: MCDERMOTT WILL & EMERY LLP, 600 13TH STREET, N.W., WASHINGTON, DC, 20005-3096, US

(21) Appl. No.: 11/319,209

(22) Filed: Dec. 28, 2005

Related U.S. Application Data
(60) Provisional application No. 60/640,060, filed on Dec. 30, 2004.

(51) Int. Cl. G01C 1/00; G01B 11/26

(52) U.S. Cl. 356/139.09; 356/155

(57) ABSTRACT

An image-based, non-contact measurement method and system for determining spatial characteristics and parameters of an object under measurement. Image capturing devices, such as cameras, are used to capture images of an object under measurement from different viewing angles. A data processing system performs computations of spatial characteristics of the object under measurement based on the captured images.

### RELATED APPLICATION

This application claims the benefit of priority from U.S. provisional patent application No. 60/640,060 filed Dec. 30, 2005, the entire disclosure of which is incorporated herein by reference.

### FIELD OF THE DISCLOSURE

The disclosure generally relates to a non-contact measurement method and system, and more specifically, to a method and system for determining positional characteristics related to a vehicle, such as wheel alignment parameters.

### BACKGROUND OF THE DISCLOSURE

Position determination systems, such as a machine vision measuring system, are used in many applications. For example, wheels of motor vehicles may be aligned using a computer-aided, three-dimensional machine vision alignment apparatus and a related alignment method. Examples of 3D alignment are described in U.S. Pat. No. 5,724,743, titled “Method and apparatus for determining the alignment of motor vehicle wheels,” and U.S. Pat. No. 5,535,522, titled “Method and apparatus for determining the alignment of motor vehicle wheels,” both of which are commonly assigned to the assignee of the present disclosure and incorporated herein for reference in their entireties.

To determine the alignment status of the vehicle wheels, some aligners use directional sensors, such as cameras, to view alignment targets affixed to the wheels to determine the position of the alignment targets relative to the alignment cameras. These types of aligners require one or more targets with known target patterns to affix to the subject under test in a known positional relationship. The alignment cameras capture images of the targets. From these images the spatial location of the wheels can be determined, and when the spatial locations of the vehicle or wheels are altered. Characteristics related to the vehicle body or wheel are then determined based on the captured images of the targets.

Although such types of alignment systems provide satisfactory measurement results, the need of attaching targets to the subject under test introduces additional work load to technicians and increases system cost. In addition, in order to attach targets to vehicle test. Different attachment devices are needed for different vehicle models, which further increase cost of the systems and complexity of inventory management.

Therefore, there is a need for a non-contact vehicle service system for obtaining characteristics related to a vehicle without using targets. There is another need to apply the same non-contact vehicle service system to different measurement purposes, such as alignment measurements or collision measurements.

### SUMMARY OF DISCLOSURE

This disclosure describes embodiments of non-contact measurement system for determining spatial characteristics of objects, such as wheels of a vehicle.

An exemplary measurement system includes at least one image capturing device configured to produce at least two images of an object from different viewing angles, and a data processing system configured to determine spatial characteristics of the object based on data derived from the at least two images.

The at least one image capturing device may include a plurality of image capturing devices. Each of the plurality of image capturing devices corresponds to a wheel of a vehicle, and is configured to produce at least two images of the wheel from different viewing angles. The exemplary system further includes a calibration arrangement for producing information representative of relative positional relationships between the plurality of image capturing devices. The data processing system is configured to determine spatial characteristics of wheels of the vehicle based on the images produced by the plurality of image capturing devices, and the information representative of relative positional relationships between the plurality of image capturing devices.

In one aspect, the calibration arrangement includes a combination of at least one calibration camera and at least one calibration target. Each of the at least one calibration camera and the at least one calibration target is attached to one of the plurality of image capturing devices in a known positional relationship. Each of the at least one calibration camera is configured to generate an image of one of the at least one calibration target. In another aspect, the calibration arrangement includes a calibration target attached to each of the plurality of image capturing devices being viewed by a common calibration camera.

According to one embodiment, the information representative of relative positional relationships between the plurality of image capturing devices are generated based on images of a plurality of calibration targets. The positional relationship between the plurality of calibration targets is known. An image of each of the plurality of calibration targets is captured by one of the at least one image capturing devices or at least one calibration camera. Each of the at least one calibration camera is attached to one of the at least one image capturing devices in a known positional relationship.

According to another example of this disclosure, the measurement system further includes a platform for supporting the vehicle at a predetermined location on the platform. A plurality of docking stations disposed at predetermined locations relative to the platform. The positional relationships between the plurality of docking stations are known. Each of the plurality of image capturing device is configured to install on one of the plurality of docking stations for capturing images of the wheel of the vehicle, and the data processing system is configured to determine spatial characteristics of the wheels of the vehicle based on the positional relationships between the plurality of docking stations and the images produced by the plurality of image capturing devices.

An exemplary measurement method of this disclosure obtains images of at least one wheel of a vehicle from two different angles, and determines spatial characteristics of the at least one wheel of the vehicle based on data related to the obtained images. In one embodiment, the exemplary method provides a plurality of image capturing devices. Each of the plurality of image capturing devices corresponds to one of the at least one wheel of the vehicle, and is configured to produce images of the corresponding wheel from two different angles. Calibration information representative of a relationship between the plurality of image capturing devices is produced. The spatial characteristics of the at least one wheel of the vehicle is determined based on the images produced by the plurality of image capturing devices, and the information representative of relative positional relationships between the image capturing devices.

In one aspect, the calibration information is generated by calibration means including a combination of at least one calibration camera and at least one calibration target. Each of the at least one calibration camera and the at least one calibration target is attached to one of the plurality of image capturing devices in a known positional relationship. Each of the at least one calibration camera is configured to generate an image of one of the at least one calibration target.

In another aspect, the calibration information is generated by calibration means including a calibration target attached to each respective image capturing device. Each calibration target is viewed by a common calibration camera.

In accordance with an embodiment of this disclosure, the calibration information is generated based on images of a plurality of calibration targets. The positional relationship between the calibration targets is known. An image of each of the plurality of calibration targets is captured by one of the at least one image capturing devices or at least one calibration camera. Each of the at least one calibration camera is attached to one of the at least one image capturing devices in a known positional relationship.

According to another embodiment, the vehicle is supported by a platform at a predetermined location on the platform. The calibration information is generated by calibration means including a plurality of docking stations disposed at predetermined locations relative to the platform. The positional relationships between the plurality of docking stations are known. Each respective image capturing device is configured to install on one of the plurality of docking stations for capturing images of a corresponding wheel of the vehicle. The spatial characteristics of the at least one wheel of the vehicle are determined based on the positional relationships between the docking stations and the images produced by the image capturing devices.

Additional advantages of the present disclosure will become readily apparent to those skilled in this art from the following detailed description, wherein only the illustrative embodiments are shown and described, simply by way of illustration of the best mode contemplated. As will be realized, the disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawings and in which like reference numerals refer to similar elements and in which like reference numerals refer to similar elements.

FIG. 1 shows a wheel being viewed by cameras utilized in an exemplary non-contact measurement system of this disclosure.

FIGS. 2A-2B illustrate sample images captured by the cameras shown in FIG. 1.

FIG. 3 shows images captured by two cameras having a known positional relationship relative to each other.

FIG. 4 illustrates a process of determining an approximation of an object under measurement.

FIG. 5 is an exemplary non-contact measurement system according to this disclosure.

FIG. 6 shows an exemplary self-calibrating, non-contact measurement system for use in vehicle measurements.

FIG. 7 shows another embodiment of an exemplary self-calibrating, non-contact measurement system according to this disclosure.

FIG. 8 shows an exemplary non-contact measurement system having a lift and docking stations.

FIGS. 9 and 10 illustrate using a non-contact measurement system according to this disclosure in collision repairs.

FIGS. 11A and 11B show exemplary images obtained by the measurement pod shown in FIG. 9.

FIG. 12 is the structure of an exemplary measurement pod for use in the system shown in FIG. 9.

FIG. 13 shows an exemplary image obtained by the measurement pod shown in FIG. 10.

FIG. 14 is the structure of an exemplary measurement pod for use in the system shown in FIG. 10.

FIGS. 15 and 16 show exemplary non-contact systems using multiple measurement pods for collision repairs.

FIG. 17 is a schematic block diagram of a data processing system that can be use to implement the non-contact measurement systems of this disclosure.

### DETAILED DESCRIPTION OF ILLUSTRATIVE EMBODIMENTS

In the following description, for the purposes of explanation, numerous specific details are set forth in order to provide a thorough understanding of the present disclosure. It will be apparent, however, to one skilled in the art that the present disclosure may be practiced without these specific details. In other instances, well-known structures and devices are shown in block diagram form in order to avoid unnecessarily obscuring the present disclosure.

### EMBODIMENT 1

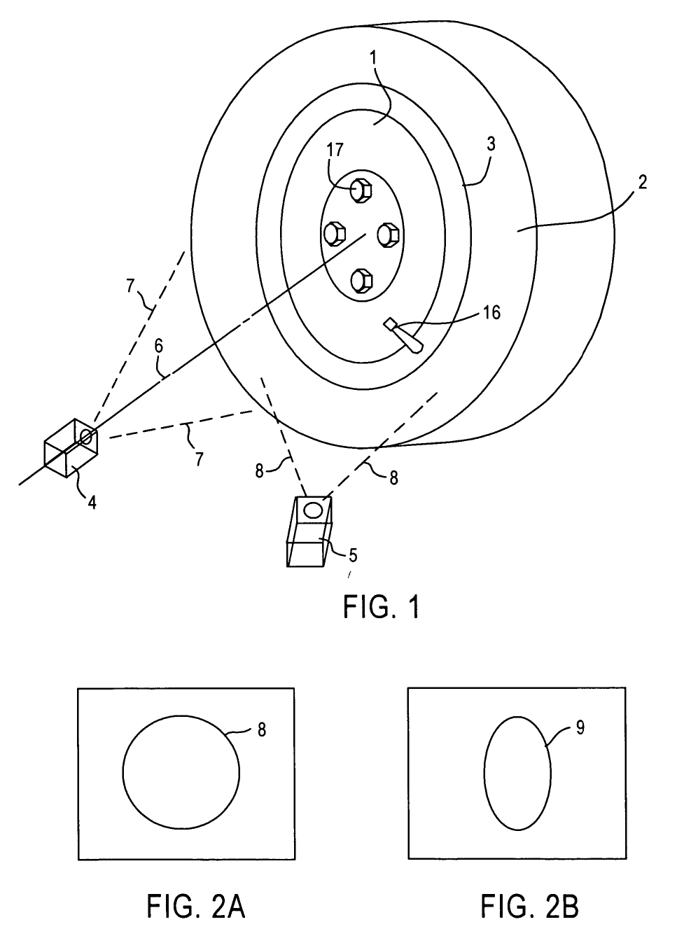

FIG. 1 shows an exemplary non-contact measurement system for measuring spatial parameters related to a wheel without the assistance from a target with known target patterns, or attachments or markings on the wheel, or pre-known features of the wheel. As shown in FIG. 1, a wheel 1 having a mounted tire 2 (collectively “wheel assembly”) is provided for measurements. Two cameras 4 and 5 are provided to view the wheel assembly, or a portion thereof. The cameras are used to provide data for imaging metrology, such as CCD or CMOS cameras. Each of the cameras has a field of view noted by dashed lines 7 and 8, respectively. The positional relationship between cameras 4 and 5 is known and/or predetermined, and is chosen so that the images of the rim circle, shown in FIGS. 2A and 2B, are sufficiently different to allow calculation of interface 3, between the sidewall of the tire and the edge of the rim on which the tire is mounted, relative to the cameras. In one embodiment, only one camera is used. At least two images of the wheel are taken by the camera from different angles. The relative spatial relationship between the two imaging angles is known. For instance, the camera can be positioned to a first predetermined location to take a first image of the wheel, and then positioned to a second predetermined location to take a second image of the wheel. According to another embodiment, the camera is stationary. Instead, after the camera takes a first image of the wheel positioned at a first location, the wheel is positioned to a second location and a second image is taken by the camera. The relative spatial relationship between the first location and the second location is known or can be derived based on the distance between the two locations and the distance from the camera to the locations, using geometry analysis known to people skilled in the art.

One technique for determining relative positions between the cameras is disclosed in U.S. Pat. No. 5,809,658, entitled “Method and Apparatus for Calibrating Alignment cameras Used in the Alignment of Motor Vehicle Wheels,” issued to Jackson et al. on Sep. 22, 1998, which is incorporated herein by reference in its entirety. Additional devices, such as a set of calibration camera and target, can be attached to cameras 4 and 5, respectively, to provide real-time calibration of the relative position between cameras 4 and 5. Exemplary approaches for determination of the relative position between cameras 4 and 5, and real-time calibration are described in U.S. patent application Ser. No. 09/576,442, filed May 20, 2000 and titled “SELF-CALIBRATING, MULTI-CAMERA MACHINE VISION MEASURING SYSTEM,” the disclosure of which is incorporated herein by reference in its entirety.

Images captured by cameras 4 and 5 are sent to a data processing system, such as a computer (not shown), for further processing of the captured images in order to determine alignment parameters of the wheel under test based on the captured images. In one embodiment, the exemplary non-contact measurement system calculates spatial parameters of wheel 1 and tire 2 based on images of a selected portion on wheel 1 and tire 2, such as interface 3. If desired, other portions on wheel 1 and tire 2 can be selected and used, such as nuts 17.

Steps and mathematical computations used in calculating wheel parameters based on the images captured by cameras 3 and 4 are now described. Let the curve described by interface 3 be called the rim circle and the plane in which this circle lies be called the rim plane. The data processing system sets up a coordinate system, such as a three-dimensional (3D) plane, to describe the spatial characteristics of wheel 1 and tire 2. This three-dimensional plane (the rim plane) may be defined by a point and three orthogonal unit vectors. The point and two of the unit vectors lie in the plane. The third unit vector is normal to the plane. Let this point be the center of the rim circle. The point is described and defined by a vector from the origin of a Cartesian coordinate system, and the three unit vectors are described and defined relative to this system. Due to the symmetry of a circle, only the center and the normal unit vector are uniquely defined. The other two unit vectors, orthogonal to each other and the normal which lie in the plane can be rotated about the normal by an arbitrary angle without changing the rim circle center or normal, unless an additional feature in the plane can be identified to define the orientation of these two vectors.

Let this Cartesian coordinate system be called the Camera Coordinate System (CCS).

The focal point of the camera is the origin of the CCS, and the directions of the camera's rows and columns of pixels define the X and Y axes, respectively. The camera image plane is normal to the Z axis, at a distance from the origin called the focal length. Since the rim circle now lies in the rim plane, the only additional parameter needed to define the rim circle is its radius.

For any position and orientation of the rim circle relative to a CCS, and in a camera's field of view, the rim circle projects to a curve on the camera image plane. Using edge detection means well known in the optical imaging field, interface 3 will be defined as curve 8 and 9 (shown in FIGS. 2A and 2B) in images captured by cameras 4 and 5, respectively. Due to the physical properties of wheel rims and tires, such as the rounded edges of some wheel rims, and the extent of rubber with some tires, the interface defining the rim circle may be fully visible, masked or partially exposed.

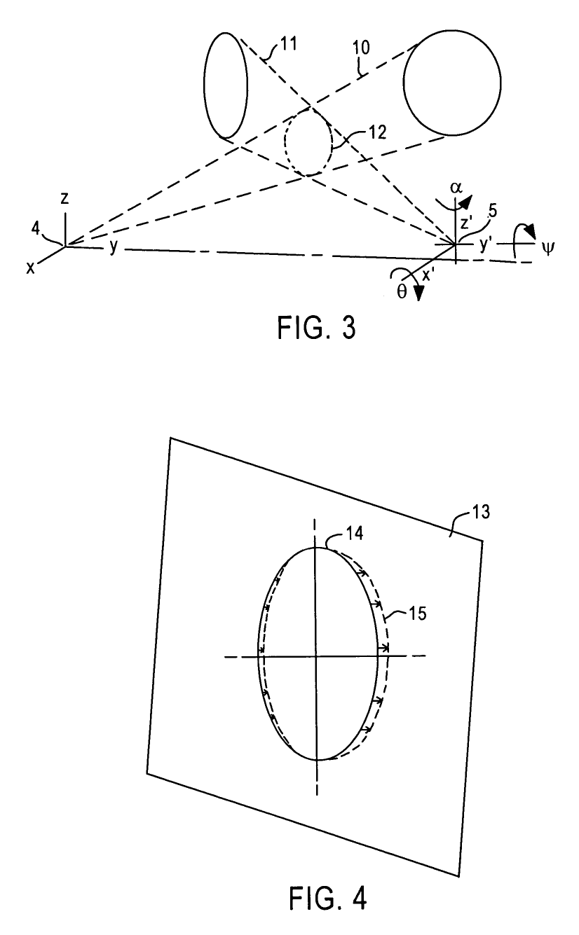

As described earlier, cameras 4 and 5 are in known positional relationship relative to each other. As illustrated in FIG. 3, camera 4 has a coordinate system having axes x,y,z, and camera 5 has a coordinate system having axes x′, y′, and z′. The relative position between cameras 4 and 5 is defined by values of linear translation, and angular rotations relative to each other. Both cameras 4 and 5 have a known focal length.

Spatial characteristics of the 3D rim circle are determined based on two-dimensional (2D) curves in camera image planes of cameras 4, 5 by using techniques described below. Since the relative position and orientation of cameras 4 and 5 are known, if the position and orientation of the rim plane and circle are defined relative to one of the cameras' CCS, the position and orientation relative to the other camera's CCS is also defined or known. If the position and orientation of the rim plane and circle are so defined relative to the CCS of a selected one of cameras 4 and 5, then the curve of the rim circle may be projected onto the selected camera image plane, and compared to the measured curve in that camera image plane obtained from the edge detection technique. Changing the position and orientation of the rim plane and circle changes the curves projected onto the camera image planes, and hence changes the comparison with the measured curves.

The position and orientation of the rim plane and circle that generate projected curves on the camera image planes that best fit the measured curves is defined as the optimal solution for the 3D rim plane and circle, given the images and measured data.

The best fit of projected to measured curves is defined as follows:

The measured curves are defined by a series of points in the camera image plane by the edge detection process. For each such point on a measured curve, the closest point on the projected curve is determined. The sum of the squares of the distances from each measured point to the corresponding closest point on the projected curve is taken as a figure of merit. The best fit is defined as that position and orientation of the rim circle and plane that minimizes the sum of both sums of squares from both cameras. The fitting process adjusts the position and orientation of the rim plane and circle to minimize that sum.

To find the closest point on the projected curve to a measured point, both in the camera image plane, an exemplary mathematical approach as described below is used:
1) Project the measured point in the camera image plane to the rim plane by extending the vector from the origin of the CCS through the measured point to the rim plane. The point of intersection of this extended vector with the rim plane is the projected point in the rim plane.
2) Find the point in the rim plane where a line from the center of the rim circle to the projected point found in step (1) above intersects the rim circle.
3) Project the intersection point found in step (2) above back to the camera image plane by finding the intersection with the camera image plane of a line from this point to the origin of the CCS. This point in the camera image plane is the closest point on the projected curve to the measured point.

The contribution to the figure of merit from this camera is the sum of the squares of the distances from all measured points in the camera image plane to the corresponding closest points on the projected curve, as found by steps (1-3) above.

Detailed mathematical computations are now described: Define:
pm A measured point in camera image plane (input), defined by camera image plane coordinates pm.x and pm.y
rr Rim circle radius (input, current value)
u Vector from focus of the CCS to the measured point with components pm.x, pm.y, and F in the CCS. F is the normal distance from the focus of the CCS to the camera image plane
r Vector parallel to u, from focus of the CCS to a point on the rim plane

The rim plane is defined relative to the CCS by:
rp.o Vector from origin of CCS to the center of the rim circle in the rim plane
rp.n Unit vector normal to the rim plane
u, the vector from focus of CCS to the measured point (x,y,z are coordinates in CCS), is givenm by:
   u.x=pm.x Eq. 1x)
   u.y=pm.y Eq. 1y)
   u.z=focalLength (Eq. 1z)

Any point in the rim plane is defined by a vector r from the origin of the CCS:
r=rp.c+q Eq. 2)
where q is a vector lying in the rim plane, from the rim plane center rp.c to r.

Since r is parallel to u:
r=k*u=rp.c+q (Eq. 3)
where k is a scalar value.

q is normal to the rim plane normal rp.n, since it lies in the rim plane, so:
q*rp.n=0 Eq. 4)

Taking the dot product of Eq. 3 with rp.n:
r*rp.n=k*(u*rp.n)=(rp.c*rp.n) Eq. 5)
k=(rp.c*rp.n)/(u*rp.n) Eq. 6)

From Eq. 3 and Eq. 6:
q=k*u−rp.c Eq. 7)

Given the current parameters of the rim plane (rp.c and rp.n) and u (pm.x, pm.y, F), Eq. 6 defines k, and Eq. 7 defines q. The magnitude of q is the square root of q*q:
Q=√(q*q)

The closest point on the rim circle is defined by a vector from the center of the rim circle (and plane) parallel to q, but having the magnitude of the radius of the rim circle:
q′=(rr/Q)*q Eq. 9)
r′=rp.c+q′ Eq. 10)

Project this point onto the camera image plane:
k′*u′=rp.c+q′ Eq 11)

Taking the Z-component in the CCS:
k′=(rp.c.z+q′.z)/u′.z=(rp.c.z+q′.z)/F Eq. 12)
u′.x=(rp.c.x+q′.x)/k=F*(rp.c.x+q′.x)/(rp.c.z+q′.z) Eq. 13x)
u′.y=(rp.c.y+q′.y)/k=F*(rp.c.y+q′.y)/(rp.c.z+q′.z) Eq. 13y)

The measured point pm should have been the projection onto the camera image plane of a point on the rim circle, so the difference between (pm.x, pm.y) and (u′.x, u′.y) on the camera image plane is a measure of the “goodness of fit” of the rim parameters (rp.c and rp.n) to the measurements. Summing the squares of these differences over all measured points gives a goodness-of-fit value:
Φ=Σ((u′.xᵢ−pm.xᵢ)²+(u′.yᵢ−pm.yᵢ)²)i=1, . . . , N Eq. 14)
where N is the number of measured points. A “least-squares fit” procedure, well know in the art, is used to adjust rp.c and rp.n, the defining parameters of the rim circle, to minimize Φ, given the measured data set {pm.xᵢ,pm.yᵢ} and the rim circle radius rr.

In a related embodiment, two cameras whose relative position is known by a calibration procedure can image the wheel and rim and the data sets from these two cameras can be used in the above calculation. In this case:
Φ=Φ₀Φ₁ Eq. 15)
where Φ₀ is defined as in Eq. 14, and Φ₁ is similarly defined for the second camera, with the following difference: the rim plane parameters rp.c and rp.n used for the second camera are transformed from the CCS of the first camera into the CCS of the second camera.
The CCS of the second camera is defined (by a calibration procedure) by a vector from the center of the first camera CCS to the center of the second camera CCS (c₁), and three orthogonal unit vectors (u0ᵢ, u1₁, u2₁). Then:
rp.0₁=(rp−c₁)*u0₁ Eq. 16.0)
rp.1₁=(rp−c₁)*u1₁ Eq. 16.1)
rp.2₁=(rp−c₁)*u2₁ Eq. 16.2)
(rp.0₁, rp.1₁,rp.2₁) are the equivalent x,y,z components of rp.c and rp.n to be used for the second camera in Eq. 1 through Eq. 14.

As illustrated above, the rim plane and circle are now determined based on two curves, comprised of sets of measured points, in camera image planes, and thus spatial characteristics of the rim plane and circle are now known. As the rim plane and circle are part of the wheel assembly (including wheel 1 and tire 2), spatial characteristics of the wheel assembly can be determined based on the spatial characteristics of the rim plane and circle.

### EMBODIMENT 2

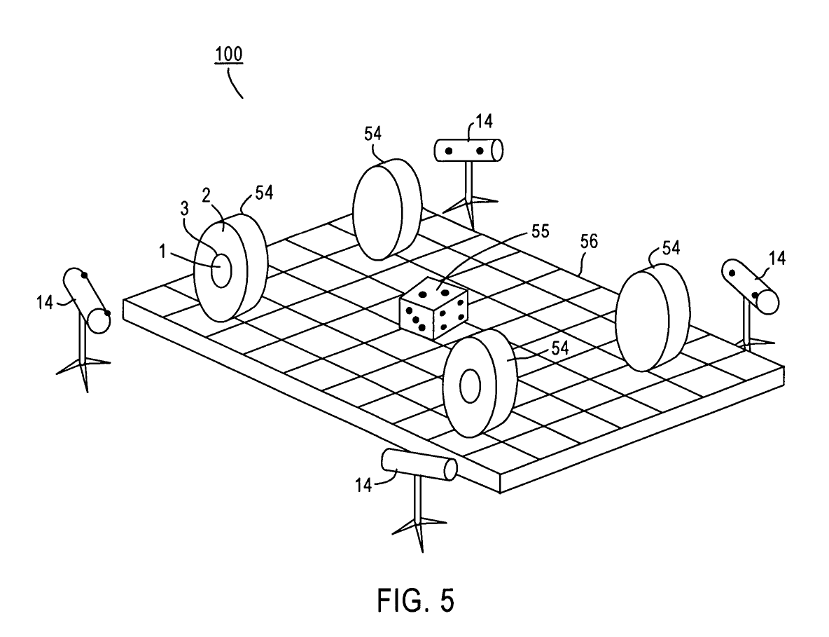

One application of the exemplary non-contact measurement system is to determine wheel alignment parameters of a vehicle, such as toe, camber, caster, etc. FIG. 5 shows an exemplary alignment system using non-contact measurements as described above. For each wheel 54, a measurement pod 14 is provided. Measurement pod 14 includes two cameras having a known positional relationship relative to each other. The cameras are configured to capture images of the wheels. Measurement pods are placed in close proximity to wheels 54 to obtain clear images of tire 1, mounting wheel 2 and edge 3 on wheel 54. The alignment system further includes a data processing system, such as a computer, that receives, or has access to, the images captured by the cameras.

A calibration process is performed to determine relative positions and angles between measurement pods 14. During the calibration process, a known object with known geometrical characteristics is provided to be viewed by each measurement pod 14, such that each measurement pod 14 generates an image representing the relative position between the object and that measurement pod. For example, as shown in FIG. 5, the measurement pods commonly view a multifaceted solid 55 with known unique markings on each face. The positional relationships between markings on each face of solid 55 are predetermined and stored in the computer. Since the relative positional relationships between the markings on each face of solid 55 are known, and the respective images of solid 55 captured by each measurement pod 14 include embedded information of the relative position between solid 55 and that measurement pod, the relative positions between the various measurement pods are determined.

In addition to solid 55 as shown in FIG. 5, other types of common object with known geometrical characteristics can be used for performing the calibration process, such as a reference platform 56 as shown in FIG. 5 with known grid lines. Other means and approaches that can be used to determine the relative positions between the measurement pods and cameras are described in U.S. Pat. No. 5,809,658, entitled “Method and Apparatus for Calibrating Alignment cameras Used in the Alignment of Motor Vehicle Wheels,” issued to Jackson et al. on Sep. 22, 1998; and in U.S. patent application Ser. No. 09/576,442, filed May 20, 2000 and titled “SELF-CALIBRATING, MULTI-CAMERA MACHINE VISION MEASURING SYSTEM,” both of which are previously incorporated by reference.

The computer derives the spatial characteristics of each wheel 54 based on the respective captured images using approaches as discussed related to embodiment 1. The computer creates and stores profiles for each wheel, including tire interface, rings, edges, rotational axis, the center of wheel 54, etc., based on the captured images. As the relative positions between the sets of cameras and measurement pods are known, the computer determines the relative spatial relationships between the wheels based on the known relative positions between the sets of cameras/measurement pods and the spatial characteristics of each wheel. Wheel locations and angles are determined based on images captured by the measurement pods, and are translated to a master coordinate system, such as a vehicle coordinate system. Wheel alignment parameters are then determined based o the respective spatial characteristics of each wheel and/or relative spatial relationships between the wheels.

For instance, after wheel locations and angles are determined and translated to a vehicle coordinate system, the computer creates a two-dimensional diagram of the wheels by projecting the wheels on to a projection plane parallel to the surface on which the vehicle rests. Axels of the vehicle are determined by drawing a line linking wheel centers on the opposite sides of the vehicle. The thrust line of the vehicle is determined by linking the middle point of each axial. Rear wheel toe angles are determined based on the wheel planes projected onto the projection plane.

### EMBODIMENT 3

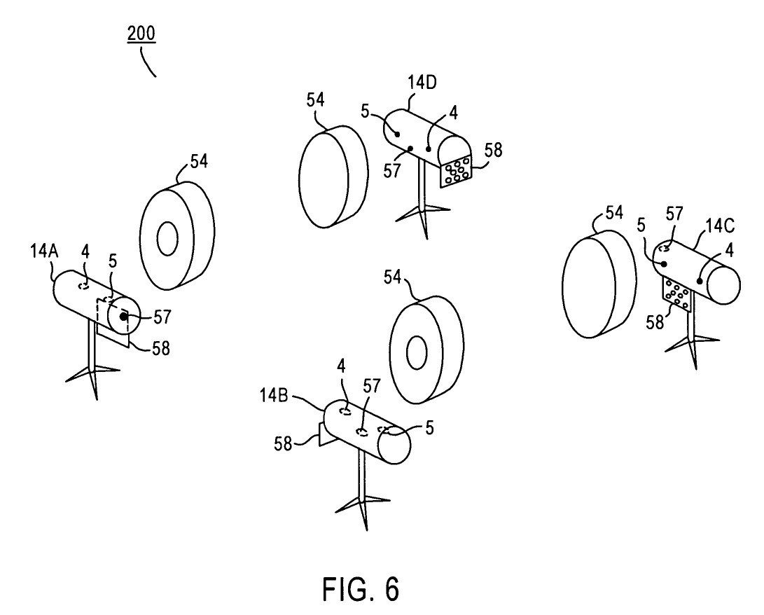

FIG. 6 shows another exemplary measurement system that embodies non-contact measurements using a different calibration approach. Multiple measurement pods 14A-14D are used to obtain images of vehicle wheels 54. Each measurement pod includes at least one imaging device for producing at least two images of a wheel. For example, each measurement pod includes two measurement cameras arranged in a known positional relationship relative to each other. Similar to embodiments described above, the system further includes a data processing system, such as a computer, that receives, or has access to, images captured by the measurement pods.

Each measurement pod further includes calibrations devices for determining relative positions between the measurement modules. For instance, measurement pod 14A includes a calibration target 58 and a calibration camera 57. Calibration camera 57 is used to view a calibration target 58 of another measurement pod 14B, and calibration target 58 on measurement pod 14A is to be viewed by calibration camera 57 of the other measurement pod 14D. Calibration target 58 and calibration camera 57 are pre-calibrated to the measuring cameras in their respective measurement pods. In other words, the relative positions between the calibration camera and target and measurement cameras in the same measurement pod are known, and data of which can be accessed by the computer. Since the relative positions between the measurement pods are determined by using the calibration targets and calibration cameras, and the relative positions between the measurement cameras and the calibration target and camera in each measurement pod are known, the relative spatial relationships between the cameras in the system can be determined. Wheel locations and angles are determined based on images captured by the measurement pods using techniques described related to embodiment 1, and are translated to a master pod coordinate system, and further to a vehicle coordinate system.

According to one embodiment, calibration target 58 and a calibration camera 57 of each measurement pod 14 are arranged in such a way that the vehicle under test does not obstruct a line-of-sight view of a calibration target by the corresponding calibration camera, such that dynamic calibrations can be performed even during the measurement process.

### EMBODIMENT 4

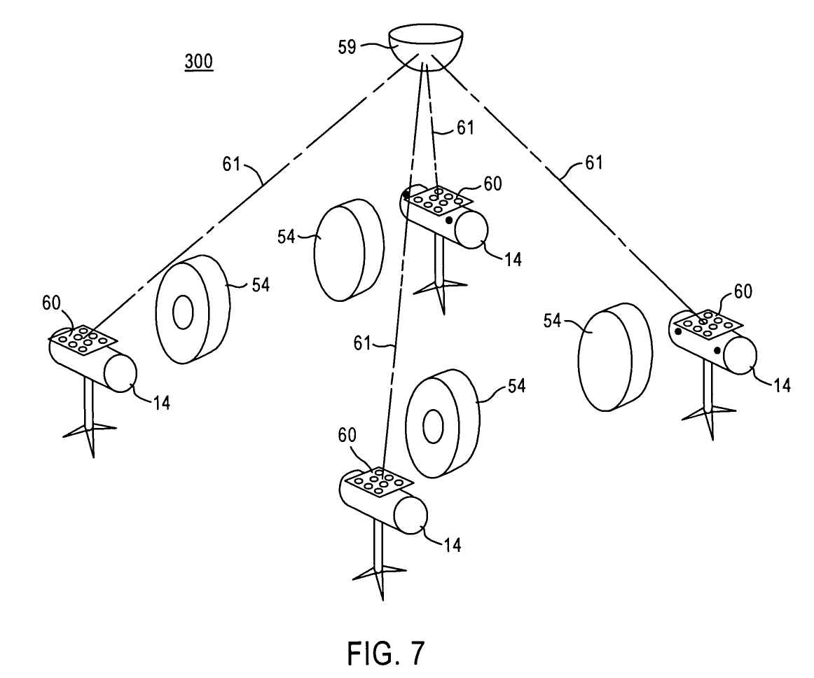

FIG. 7 shows another exemplary measurement system 300 that embodies non-contact measurements using yet another calibration approach. Certain devices and components of system 300 are similar to those shown in FIG. 6, and like reference numbers are used to refer to like items. System 300 includes multiple measurement pods 14 to capture images of vehicle wheels 54. Each measurement pod 14 includes at least one imaging device for producing at least two images of a wheel. For example, measurement pod 14 includes two cameras arranged in a known positional relationship relative to each other. Similar to the embodiments described above, system 300 further includes a data processing system, such as a computer, that receives, or has access to, images captured by the measurement pods. Furthermore, each measurement pod 14 includes a calibration target 60, which is viewed by a common calibration camera 59 located at a location, such as the ceiling of a garage, that would not be obstructed by a vehicle or object under measurement, and maintains a line-of-sight view of the calibration targets 60. The calibration target 60 and cameras of each measurement pod 14 are pre-calibrated. In other words, the relative positions of the calibration target and cameras in the same measurement pod are known, and data of which can be accessed by the computer.

The computer determines the relative locations and angles between measurement pods 14 based on images of calibration target 60 of each measurement pod 14 that are captured by common calibration camera 59. Since the relative positions between measurement pods are now known, and the relative positions between the cameras and the calibration target 60 in each measurement pod 14 are predetermined, the relative spatial relationships between the cameras in the system can be derived. Wheel locations and angles are determined based on images captured by the measurement pods, and are translated to a master pod coordinate system, and further to a vehicle coordinate system.

In another embodiment, calibration target 60 in each measurement pod is substituted by a calibration camera, and the common calibration camera 59 is substitute by a common calibration target. Again, the calibration camera and measurement cameras of each measurement pod 14 are pre-calibrated. Thus, the relative positional relationships between measurement pods or cameras can be determined based on images of the common calibration target captured by the calibration cameras. Spatial characteristics of the wheels are determined using techniques described related to embodiment 1.

### EMBODIMENT 5

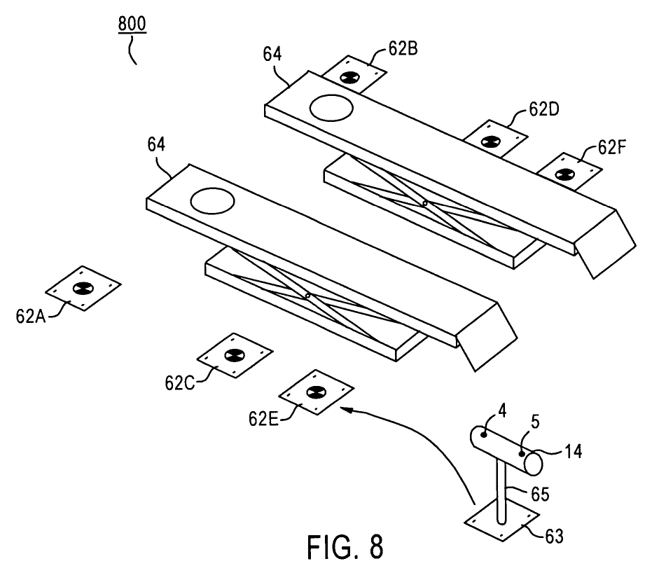

FIG. 8 shows another exemplary measurement system 800 that embodies non-contact measurements according to this disclosure. System 800 includes a platform, such as a lift 64, for supporting a vehicle at a prescribed location thereon. One or more pre-measured docking stations 62A-62F are provided around lift 64. Each docking station 62 has a predetermined or known positional relationship relative to other docking stations 62. One or more measurement pods 14 are supported on a pedestal 65 attaching to a base 63. The base is made to adapt to the docking stations 62 in a unique and pre-established relationship.

Each measurement pod 14 includes at least one imaging device for producing at least two images of a wheel. For example, each measurement pod 14 includes two cameras 4, 5 arranged in a known positional relationship relative to each other. Similar to embodiments described above, system 800 further includes a data processing system, such as a computer (not shown), that receives, or has access to, images captured by the measurement pods 14. The positional relationships between the cameras 4, 5 and base 63 are established in a calibration process.

Locations of docking stations 62 are prearranged to accommodate vehicles with different dimensions, such that measurement pods 14 will be in an acceptable range to vehicle wheels after installation. For example, a short wheelbase vehicle might use docking stations 62A, 62B, 62C, and 62D, while a longer vehicle might use docking stations 62A, 62B, 62E, and 62F. By installing measurement pods 14 on predetermined docking stations 62, the relative positions between measurement pods 14 are known. The computer determines wheel alignment parameters or other types of parameters related to a vehicle under test using methods and approaches described in previous embodiments.

In embodiments 2-5 described above, although four measurement pods are shown for performing non-contact measurements for a vehicle having four wheels (one measurement pod for each wheel), these systems can perform the same functions using fewer measurement pods. For instance, in system 100 as shown in FIG. 5, the multiple-pod configuration can be simulated by time-serialized measurements by using less than four measurement pods. If only one measurement pod is utilized, the measurement pod is moved from one location to another to capture images of each wheel and multifaceted solid 55 from each respective location. Similarly, systems 300 and 800 as shown in FIGS. 7 and 8 can perform the same functions by using only one measurement pod, moving from one location to another. System 200 as shown in FIG. 6 can perform the same functions by using only three measurement pods. In operation, each of the three measurement pods is installed in association with a wheel. A first set of images of wheels and calibration targets are taken for determining spatial characteristics of the three wheels and the relative positions between the measurement pods. Then, one of the three measurement pods is moved and installed near the fourth wheel. Other measurement pods remain at the original locations. A second set of images of wheels and calibration targets are then taken for determining the spatial characteristics of the fourth wheel and the relative positional relationship between the relocated measurement pod and at least one of the unmoved measurement pods. The relative positions and spatial characteristics of the wheels are determined based on the first and second sets of images.

Another application of the exemplary non-contact measurement system is for determining whether a wheel or vehicle body has an appropriate shape or profile. The computer stores data related a prescribed shape or profile of a wheel or vehicle body. After the non-contact measurement system obtains a profile of a wheel or vehicle body under measurement, the measured profile is compared with the prescribed shape/profile to determine whether the shape complies with specifications. If the difference between the prescribed shape and the measured profile of the wheel or vehicle body under test exceeds a predetermined threshold, the computer determines that the wheel or vehicle body is deformed.

### EMBODIMENT 6

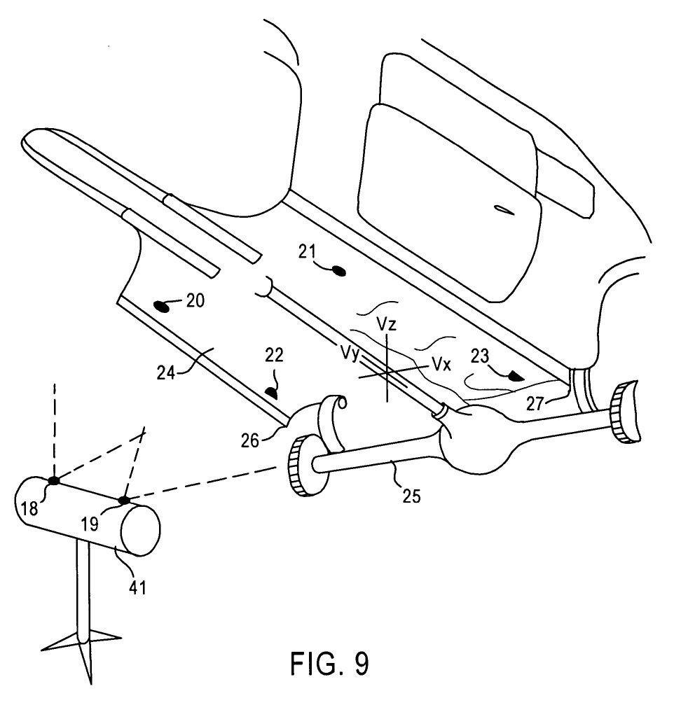

FIG. 9 shows another embodiment of a non-contact measurement system according to the concepts of this disclosure. Cameras 18, 19 are enclosed in a structure, such as a mobile pod 41, to measure reference points 20, 21, 22, 23 on a vehicle body 24, or to measure components 25 attached to the body, or to measure identifiable characteristics on the vehicle, such as the ends of the pinch flange 26, 27. Other arrangements of cameras also can be used, such as those shown in FIG. 1.

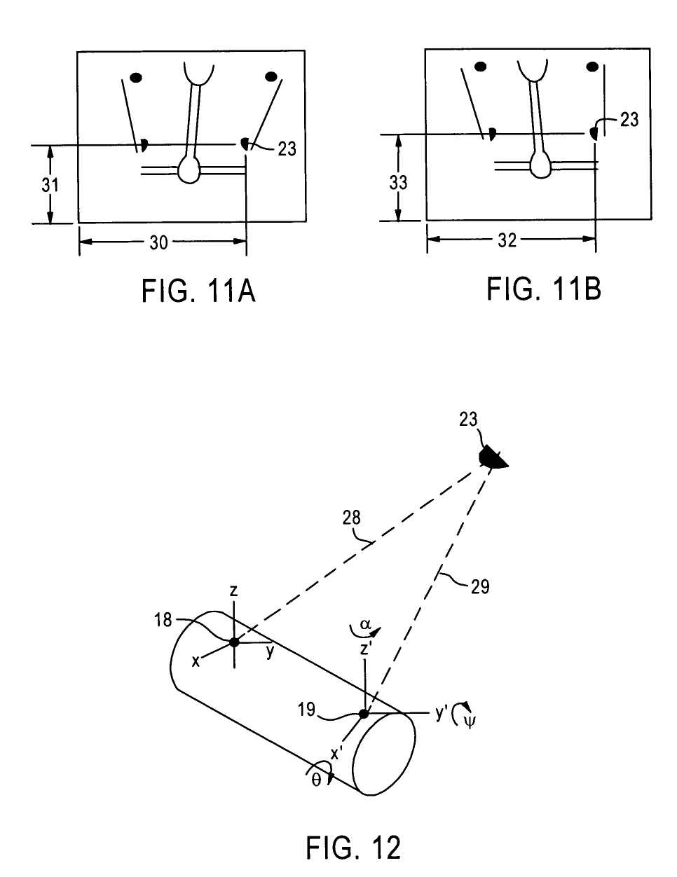

Images captured by cameras 18 and 19 are sent to a data processing system, such as a computer (not shown), for further processing. Representative images obtained by cameras 18, 19 are shown in FIGS. 11A and 11B, respectively. By use of stereo image matching, and determination of common features, a common point of interest 23 in the respective images captured by cameras 18, 19 (as shown in FIGS. 11A and 11B) is identified. A coordinate system (x, y, z) is set up for each of cameras 18, 19. From the pixel location of the image of point 23 captured by camera 18, the relative position between point 23 and camera 18 as shown in FIG. 12 can be represented by a path 28 connecting point 23 and camera 18, which is described by the coordinate system (x, y, z) set up for camera 18. Likewise, from the pixel location of the image of point 23 captured by camera 19, the relative position between point 23 and camera 19 can be represented by a path 29 connecting point 23 and camera 19, which is described by a coordinate system (x′, y′, z′) set up for camera 19. Paths 28 and 29 intersect at point 23. The relative position between cameras 18, 19 is predetermined or pre-calibrated, and such information is stored in, or accessible by, the computer. Therefore, the coordinates of the point of interest 23 relative to camera 18 may be calculated by finding the common point, which is the intersection of the paths 28, 29. Other points of interest 20, 21, 22, 26, 27 are similarly calculated in x, y, z coordinates relative to the coordinate system of camera 18. If preferred, a new coordinate system (Vx, Vy, Vz) can be set up for the vehicle based on the known coordinates of points relative to the coordinate system of camera 18 or 19.

The computer also stores, or has access to, data related to specifications for the locations of many pre-identified points on the vehicle, such as points 20, 21, 22, 23, 26, 27. Deviation of the spatial location of the measured points from the specification is an indication of damage of vehicle body or structure. A display of the computer may display prompts to a user regarding the existence of deformation, and provide guidance on corrections of such distortion or deformation using methods well known in the collision repair field of art.

Steps and mathematical computations performed by the computer to determine the spatial locations of the points based on images captured by cameras 18, 19 are now described.

In a Camera Coordinate System (CCS), the origin lies at the focal point of the camera. As shown in FIG. 12, the Z axis is normal to the camera image plane. The X and Y axes lie in the camera image plane. The focal length F is the normal distance from the focal point/origin to the camera image plane. The CCS coordinates of the center of the camera image plane is (0, 0, F). Let a ray (a line in space) be defined by a vector P from the origin to a point on the ray, and a unit vector U in the direction of the ray. Then the vector from the origin to any point on the ray is given by:
R=P+(t* U) 22)

where t is a scalar variable. The coordinates of this point are the components of R in the CCS: Rx, Ry and Rz.

If there are two cameras, and thus two Camera Coordinate Systems are available, let CCS0 be the CCS of camera 18 and CCS1 be the CCS of camera 19. As described above, the relative position between cameras 18 and 19 is known. Thus, let C1 be the vector from the origin of CCS0 to the origin of CCS1, and U1X, U1Y and U1Z be the unit vectors of CCS1 defined relative to CCS0. Let R0 be a point on the image plane of camera 18, at pixel coordinates x0,y0. The coordinates of this point are (x0,y0,F0), where F0 is the focal length of the master camera. R0 is also a vector from the origin of CCS0 to this point. Let U0 be a unit vector in the direction of R0. Then:
U0=R0/|R0| 23)

Let this be the unit vector of the path connecting point 23 and camera 18. For this path, P=0. Let R1 be a point on the second camera image plane, at pixel coordinates x1,y1. The coordinates of this point, in CCS1, are (x1,y1,F1), where F1 is the focal length of the second camera. R1 is also a vector from the origin of CCS1 to this point. Let U1 be a unit vector in CCS1 in the direction of R1. Then, in CCS0:
R1=C1+(x1*U1X)+(y1*U1Y)+(F1*U1Z) 24)
U1=(R1−C1)/|R1−C1| 25)

Let U1 be the unit vector of a second path connecting point 23 and camera 19. In CCS0, P for the second path is C1. Coordinates of points on the first path are:
PR0=t0*U0 26)

Coordinates of points on the second path are
PR1=C1+(t1*U1) 27)

The points of closest approach of these two paths are defined by:
t0=((C1*U0)−(U0*U1)(C1*U1))/D 28a)
t1=((C1*U0)(U0*U1)−(C1*U1))/D 28b)
D=1.−(U0*U1)² 28c)

With PR0 and PR1 defined by equations 26 and 27, and with t0 and t1 derived from equations 28a and 28b, the distance between these points is:
d=|PR1−PR0| 29)

and the point of intersection of the rays is defined as the midpoint:
PI=(PR1+PR0)/2 30)

Thus, using the approaches as described above, the computer determines spatial parameters of a point based on images captured by cameras 18 and 19.

### EMBODIMENT 7

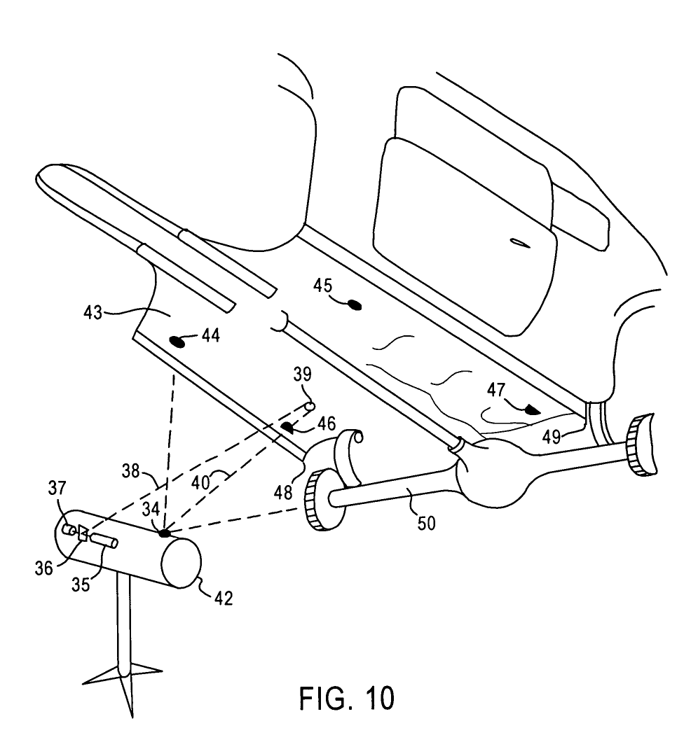

FIG. 10 shows another embodiment of a non-contact measurement system according to concepts of this disclosure. The system includes a measurement module having a single camera 34 and a source of collimated light 35, such as a laser, enclosed in a housing 42. The measurement module is used to measure the position of reference points 44, 45, 46, 47 on the surface of any 3D object, such as a vehicle, relative to a coordinate system of the camera-light-source, if the points are in the field of view of the camera and in an unobstructed line-of-sight to the light source. The exemplary system is used to measure the position of points on a vehicle body 43, or to measure components 50 attached to the body, or to measure commonly identifiable characteristics of a vehicle, such as the ends of the pinch flanges 48, 49. The system further includes a data processing system, such as a computer, configured to receive data related to images captured by camera 34.

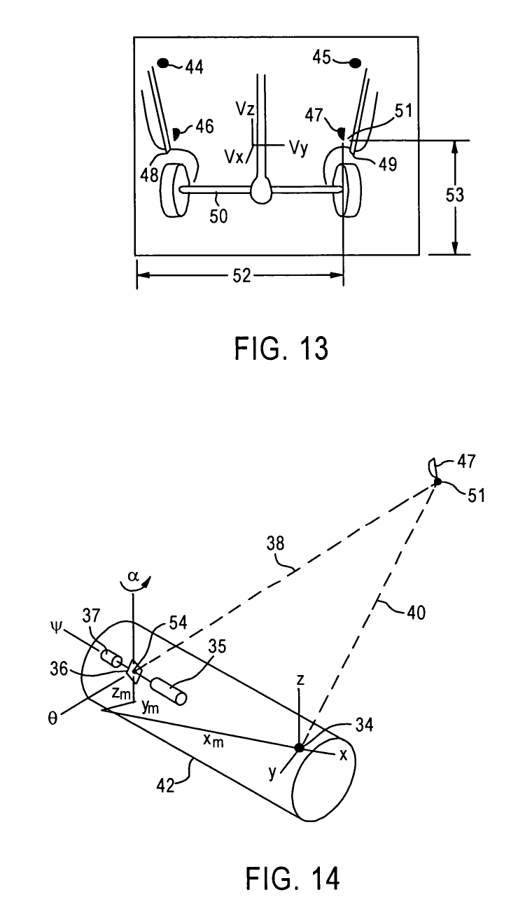

Laser 35 is aimed using a mirror 36 and a control device 37, controlled by the computer (not shown) in a manner to aim a ray of light 38 onto a region of interest on vehicle body 43, such as spot 39, which reflects a ray 40 into camera 34. The origin and orientation of ray 38 are known relative to the Camera Coordinate System (CCS) of camera 34, as ray 38 is moved under control of the computer. As shown in FIG. 13, the projected light spot 51, in the field of view of camera 34, is located at x location 52 and y location 53. The spatial position of the projected light spot 51 is calculated by triangulation as x, y, z coordinates in the camera coordinate system. Detailed mathematical analyses on how the coordinates of point 51 are determined will be described shortly.

By scanning the light around a point of interest, such as a known point 47, the point's position in the coordinate system of camera 34 is calculated. Likewise, by scanning the spot over the entire vehicle body 43, all features of interest may be mapped in the CCS of camera 34. The relative positions of the camera, the laser system and its rotations are calibrated by means common to the art of structured light vision metrology. When datum points 45, 46, 47 are identified and located in space, information related to spatial parameters of the datum points is transposed into the vehicle's coordinate system (Vx, Vy, Vz). Other points of interest, such as point 44, may be expressed relative to the vehicle's coordinate system. The computer stores, or has access to, data related to specifications for the locations of many points on the vehicle. Deviation of the spatial location of the measured points from the specification is an indication of damage of vehicle body or structure. A display of the computer may display prompts to a user regarding the existence of deformation, and provide guidance on corrections of such distortion or deformation using methods well known in the collision repair field of art.

The detailed process and mathematical computation for determining spatial parameters of points of interests are now described. In the Camera Coordinate System (CCS), the origin lies at the focal point of camera 34. The Z axis is normal to the camera image plane, and the X and Y axes lie in the camera image plane. The focal length F of camera 34 is the normal distance from the focal point/origin to the camera image plane. The CCS coordinates of the center of the camera image plane is (0, 0, F).

Let a ray (a line in space) be defined by a vector P from the origin to a point on the ray, and a unit vector U in the direction of the ray. Then the vector from the origin to any point on the ray is given by:
R=P+(t*U) 1)

where t is a scalar variable. The coordinates of this point on the ray are the components of R in the CCS: Rx, Ry and Rz.

In FIG. 14, two rays 38, 40 related to camera 34 and light projector 54 are shown. The first ray is from the origin of the CCS of camera 34 to the point in space where the light ray hits a point of interest on the surface of the 3D object. This ray also intersects the camera image plane. The second ray is from the light projector 54 to the same point on the object.

For the first ray, choose P as the origin of the CCS, so P=0, and let R0 be a point on the camera image plane, at pixel coordinates x0,y0. The coordinates of this point are (x0,y0,F0), where F0 is the focal length of the camera. R0 is also a vector from the origin of the CCS to this point. Let U0 be a unit vector in the direction of R0. Then:
U0=R0/|R0| 2)

and the vector from the origin of the CCS to the point on the object is:
RP0=t0*U0 3)

As described earlier, the relative position and orientation of the light projector 54 relative to the CCS of camera 34 are predetermined by, for example, a calibration procedure. Therefore, points on the second ray are given by:
RL=PL+(tL*UL) 4)

PL and UL are known from the calibration procedure, as the movement of light is controlled by the computer.

The point on this second ray (the light ray) where it hits the 3D object is:
RPL=PL+(tL*UL) (5)

The points of closest approach of these two rays are defined by:
t0=((PL*U0)−(U0*UL)(PL*UL))/D 6a)
tL=((PL*U0)(U0*UL)−(PL*UL))/D 6b)
D=1.−(U0*UL)² 6c)

With RP0 and RPL defined by equations (3) and (5), and with t0 and tL derived from equation (6), the distance between these points is:
d=|RPL−RP0| 7)

The point of intersection of the rays is defined as the midpoint:
PI=(RPL+RP0)/2 8)

### EMBODIMENT 8

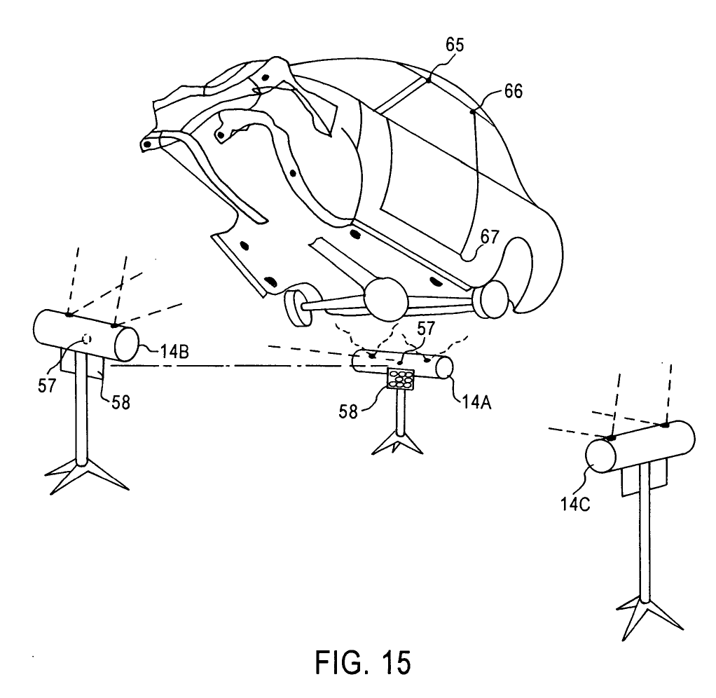

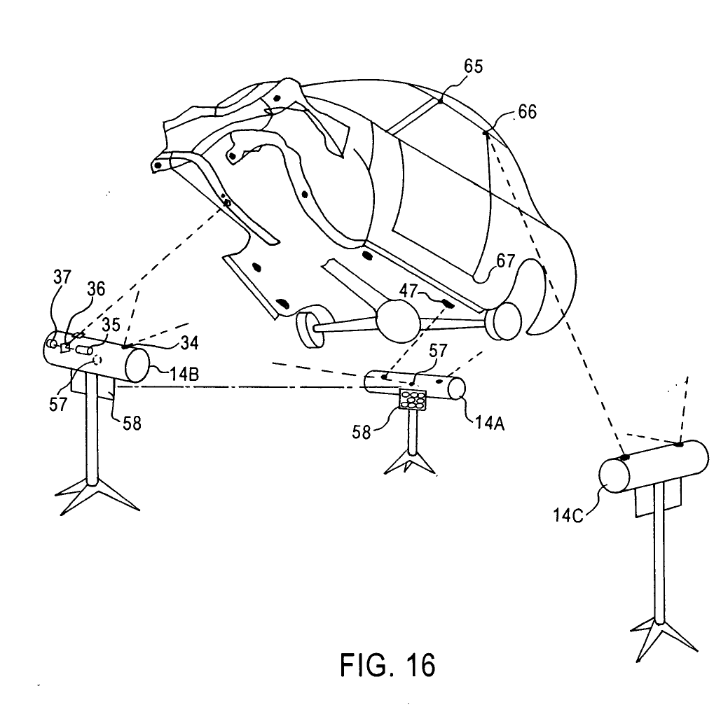

FIG. 15 shows another exemplary system that uses non-contact measurements in collision repairs. The system includes multiple measurement pods, each of which has a single camera and structured light. The structure of the camera and structured light is similar to that shown in FIGS. 10 and 14. Measurement pod 14A is utilized to view undamaged vehicle datum holes in the underbody, and measurement pod 14B is used to measure a damaged portion of the vehicle, such as the front, where predetermined datum holes are too distant or obscured by clamping or pulling devices (not shown) for making corrections. Measurement pods 14A and 14B utilize calibration devices for determining the relative position therebetween. For example, as shown in FIG. 16, a set of calibration camera 57 and calibration target 58 are utilized to establish relative positions between measurement pods 14A and 14B.

A third measurement pod 14C is also used to measure the upper body reference points, of the A-pillar 65, B pillar 66, and the corner of door 67. Measurement pod 14C may also be used to make redundant measurements of common points measured by pods 14A or 14B, in order to improve measurement accuracy, or to allow blockage of some of the points of interest in some views, necessitated by the use of clamping or pulling equipment. Although this system shows the geometric identifiers of cameras and targets, the relative pod positions may also be established by viewing of a common known object by the measurement pods or by an external camera system, or by the use of docking stations as described earlier.

FIG. 16 shows another embodiment using non-contact measurement techniques of this disclosure for collision repair. The system shown in FIG. 16 is substantially similar to the system shown in FIG. 15, except for the detailed structure of measurement pods used to obtain images. A measurement pod used in the system shown in FIG. 16 includes two measurement cameras rather than a combination of a camera and a structured light as shown in FIG. 15.

### The Data Processing System

The data processing system used in the above-described systems performs numerous tasks, such as processing positional signals, calculating relative positions, providing a user interface to the operator, displaying alignment instructions and results, receiving commands from the operator, sending control signals to reposition the alignment cameras, etc. The data processing system receives captured images from cameras and performs computations based on the captured images. Machine-readable instructions are used to control the data processing system to perform the functions and steps as described in this disclosure.

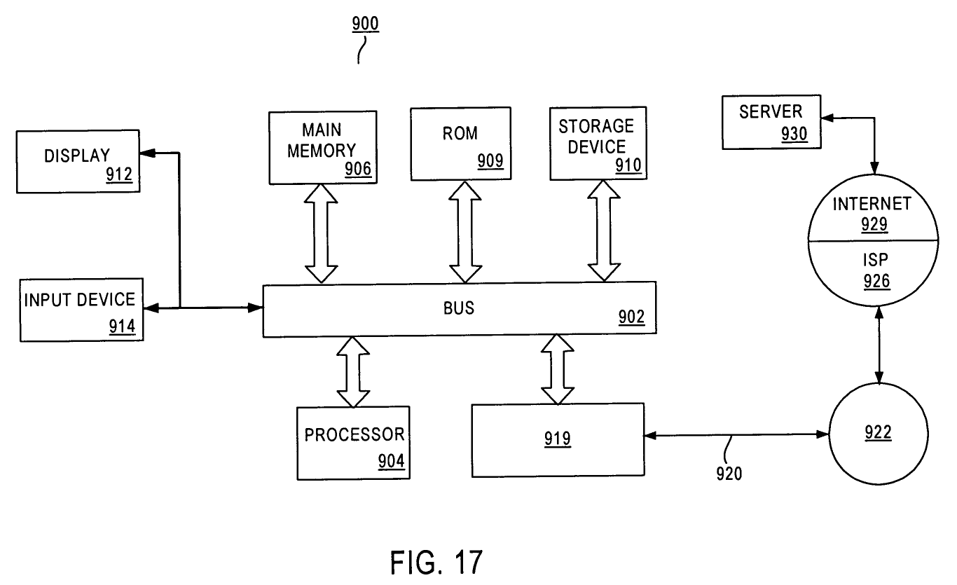

FIG. 17 is a block diagram that illustrates a data processing system 900 upon which an embodiment of the disclosure may be implemented. Data processing system 900 includes a bus 902 or other communication mechanism for communicating information, and a processor 904 coupled with bus 902 for processing information. Data processing system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Data processing system 900 further includes a read only memory (R0M) 909 or other static storage device coupled to bus 902 for storing static information and instructions for processor 904. A storage device 910, such as a magnetic disk or optical disk, is provided and coupled to bus 902 for storing information and instructions.

Data processing system 900 may be coupled via bus 902 to a display 912, such as a cathode ray tube (CRT), for displaying information to an operator. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912.

The data processing system 900 is controlled in response to processor 904 executing one or more sequences of one or more instructions contained in main memory 906. Such instructions may be read into main memory 906 from another machine-readable medium, such as storage device 910. Execution of the sequences of instructions contained in main memory 906 causes processor 904 to perform the process steps described herein. In alternative embodiments, hard-wired circuitry may be used in place of or in combination with software instructions to implement the disclosure. Thus, embodiments of the disclosure are not limited to any specific combination of hardware circuitry and software.

The term “machine readable medium” as used herein refers to any medium that participates in providing instructions to processor 904 for execution. Such a medium may take many forms, including but not limited to, non-volatile media, volatile media, and transmission media. Non-volatile media includes, for example, optical or magnetic disks, such as storage device 910. Volatile media includes dynamic memory, such as main memory 906. Transmission media includes coaxial cables, copper wire and fiber optics, including the wires that comprise bus 902. Transmission media can also take the form of acoustic or light waves, such as those generated during radio-wave and infra-red data communications.

Common forms of machine readable media include, for example, a floppy disk, a flexible disk, hard disk, magnetic tape, or any other magnetic medium, a CD-R0M, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 904 for execution. For example, the instructions may initially be carried on a magnetic disk of a remote data processing. The remote data processing system can load the instructions into its dynamic memory and send the instructions over a telephone line using a modem. A modem local to data processing system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Data processing system 900 also includes a communication interface 919 coupled to bus 902. Communication interface 919 provides a two-way data communication coupling to a network link 920 that is connected to a local network 922. For example, communication interface 919 may be an integrated services digital network (ISDN) card or a modem to provide a data communication connection to a corresponding type of telephone line. As another example, communication interface 919 may be a local area network (LAN) card to provide a data communication connection to a compatible LAN. Wireless links may also be implemented. In any such implementation, communication interface 919 sends and receives electrical, electromagnetic or optical signals that carry digital data streams representing various types of information.

Network link 920 typically provides data communication through one or more networks to other data devices. For example, network link 920 may provide a connection through local network 922 to a host data processing system 924 or to data equipment operated by an Internet Service Provider (ISP) 926. ISP 926 in turn provides data communication services through the world wide packet data communication network now commonly referred to as the “Internet” 929. Local network 922 and Internet 929 both use electrical, electromagnetic or optical signals that carry digital data streams. The signals through the various networks and the signals on network link 920 and through communication interface 919, which carry the digital data to and from data processing system 900, are exemplary forms of carrier waves transporting the information.

Data processing system 900 can send messages and receive data, including program code, through the network(s), network link 920 and communication interface 919. In the Internet example, a server 930 might transmit a requested code for an application program through Internet 929, ISP 926, local network 922 and communication interface 919. In accordance with embodiments of the disclosure, one such downloaded application provides for automatic calibration of an aligner as described herein.

The data processing also has various signal input/output ports (not shown in the drawing) for connecting to and communicating with peripheral devices, such as USB port, PS/2 port, serial port, parallel port, IEEE-1394 port, infra red communication port, etc., or other proprietary ports. The measurement modules may communicate with the data processing system via such signal input/output ports.

The disclosure has been described with reference to specific embodiments thereof. It will, however, be evident that various modifications and changes may be made thereto without departing from the broader spirit and scope of the disclosure. The specification and drawings are, accordingly, to be regarded in an illustrative rather than a restrictive sense.

What is claimed is:

1. A measurement system comprising:
at least one image capturing device configured to produce at least two images of an object from different viewing angles; and
a data processing system configured to determine spatial characteristics of the object based on data derived from the at least two images.

2. The system of claim 1, wherein:
the at least one image capturing device includes a plurality of image capturing devices;
each of the plurality of image capturing devices corresponds to a wheel of a vehicle, and is configured to produce at least two images of the wheel from different viewing angles;
the system of claim 1 further includes a calibration arrangement for producing information representative of relative positional relationships between the plurality of image capturing devices; and
the data processing system is configured to determine spatial characteristics of wheels of the vehicle based on the images produced by the plurality of image capturing devices, and the information representative of relative positional relationships between the plurality of image capturing devices.

3. The system of claim 2, wherein:
the calibration arrangement includes a combination of at least one calibration camera and at least one calibration target;
each of the at least one calibration camera and the at least one calibration target is attached to one of the plurality of image capturing devices in a known positional relationship; and
each of the at least one calibration camera is configured to generate an image of one of the at least one calibration target.

4. The system of claim 2, wherein the calibration arrangement includes a calibration target attached to each of the plurality of image capturing devices being viewed by a common calibration camera.

5. The system of claim 2, wherein:
the information representative of relative positional relationships between the plurality of image capturing devices are generated based on images of a plurality of calibration targets,
the positional relationship between the plurality of calibration targets is known,
an image of each of the plurality of calibration targets is captured by one of the at least one image capturing devices or at least one calibration camera, and
each of the at least one calibration camera is attached to one of the at least one image capturing devices in a known positional relationship.

6. The system of claim 2 further including:
a platform for supporting the vehicle at a predetermined location on the platform;
a plurality of docking stations disposed at predetermined locations relative to the platform, wherein the positional relationships between the plurality of docking stations are known; and
each of the plurality of image capturing device is configured to install on one of the plurality of docking stations for capturing images of the wheel of the vehicle;
wherein the data processing system is configured to determine spatial characteristics of the wheels of the vehicle based on the positional relationships between the plurality of docking stations and the images produced by the plurality of image capturing devices.

7. The system of claim 1, wherein the object is a vehicle wheel.

8. A measurement system comprising:
imaging means for producing at least two images of an object from different viewing angles; and
data processing means for determining spatial characteristics of the object based on data derived from the at least two images.

9. The system of claim 8, wherein:
the imaging means includes a plurality of image capturing devices;
each of the plurality of image capturing devices corresponds to a wheel of a vehicle, and is configured to produce at least two images of the wheel from different viewing angles;
the system of claim 8 further includes calibration means for producing information representative of relative positional relationships between the plurality of image capturing devices; and
the data processing means determines spatial characteristics of wheels of the vehicle based on the images produced by the plurality of image capturing devices, and the information representative of relative positional relationships between the plurality of image capturing devices.

10. The system of claim 9, wherein:
the calibration means includes a combination of at least one calibration camera and at least one calibration target;
each of the at least one calibration camera and the at least one calibration target is attached to one of the plurality of image capturing devices in a known positional relationship; and
each of the at least one calibration camera is configured to generate an image of one of the at least one calibration target.

11. The system of claim 9, wherein the calibration means includes a calibration target attached to each of the plurality of image capturing devices being viewed by a common calibration camera.

12. The system of claim 9, wherein:
the information representative of relative positional relationships between the plurality of image capturing devices are generated based on images of a plurality of calibration targets,
the positional relationship between the calibration targets is known,
an image of each of the plurality of calibration targets is captured by one of the at least one image capturing devices or at least one calibration camera, and
each of the at least one calibration camera is attached o one of the at least one image capturing devices in a known positional relationship.

13. The system of claim 9 further including:
means for supporting the vehicle at a predetermined location on the supporting means; and
docking means, disposed at predetermined locations relative to the supporting means, for receiving a respective one of the plurality of image capturing devices;
wherein:
the positional relationships between the plurality of docking stations are known;
each of the imaging image capturing devices is configured to install on one of the docking means for capturing images of a wheel of the vehicle; and
the data processing system is configured to determine spatial characteristics of the wheels of the vehicle based on the positional relationships between the docking means and the images produced by the plurality of image capturing devices.

14. The system of claim 8, wherein the object is a wheel.

15. A measurement method including the steps of:
obtaining images of at least one wheel of a vehicle from two different angles; and
determining spatial characteristics of the at least one wheel of the vehicle based on data related to the obtained images.

16. The method of claim 15 further including the steps of:
providing a plurality of image capturing devices, wherein each of the plurality of image capturing devices corresponds to one of the at least one wheel of the vehicle, and is configured to produce images of the corresponding wheel from two different angles;
producing calibration information representative of a relationship between the plurality of image capturing devices; and
determining the spatial characteristics of the at least one wheel of the vehicle based on the images produced by the plurality of image capturing devices, and the information representative of relative positional relationships between the image capturing devices.

17. The method of claim 16, wherein:
the calibration information is generated by calibration means including a combination of at least one calibration camera and at least one calibration target;
each of the at least one calibration camera and the at least one calibration target is attached to one of the plurality of image capturing devices in a known positional relationship; and
each of the at least one calibration camera is configured to generate an image of one of the at least one calibration target.

18. The method of claim 16, wherein:
the calibration information is generated by calibration means including a calibration target attached to each respective image capturing device, and
each calibration target is viewed by a common calibration camera.

19. The method of claim 16, wherein:
the calibration information is generated based on images of a plurality of calibration targets,
the positional relationship between the calibration targets is known,
an image of each of the plurality of calibration targets is captured by one of the at least one image capturing devices or at least one calibration camera, and
each of the at least one calibration camera is attached to one of the at least one image capturing devices in a known positional relationship.

20. The method of claim 16, wherein:
the vehicle is supported by a platform at a predetermined location on the platform;
the calibration information is generated by calibration means,
the calibration means includes:
a plurality of docking stations disposed at predetermined locations relative to the platform, wherein the positional relationships between the plurality of docking stations are known; and
each respective image capturing device is configured to install on one of the plurality of docking stations for capturing images of a corresponding wheel of the vehicle; and
the spatial characteristics of the at least one wheel of the vehicle are determined based on the positional relationships between the docking stations and the images produced by the image capturing devices.
